(19) United States
(12) Patent Application Publication
(10) Pub. No.: US 2017/0236670 A1
(43) Pub. Date: Aug. 17, 2017

(54) CIRCUIT BREAKER HAVING A FLOATING MOVEABLE CONTACT

(71) Applicant: General Electric Company, Schenectady, NY (US)

(72) Inventors: Derry Robert Coles, Madrid (ES); Pablo Cejudo Benito, Mostoles Madrid (ES); Jaime Sosa Rincon, Mostoles Madrid (ES)

(21) Appl. No.: 14/888,943

(22) PCT Filed: Nov. 5, 2014
(86) PCT No.: PCT/ES2014/070826

§ 371 Date: Feb. 16, 2017

(51) Int. Cl. H01H 71/02; H01H 71/10

(52) U.S. Cl. CPC H01H 71/0207; H01H 71/10; H01H 2205/002; H01H 2235/01

(57) ABSTRACT

A circuit breaker includes a housing, a fixed contact mounted in the housing, a pivot member arranged in the housing, and a pivoting arm moveably mounted in the housing. The pivoting arm includes a moveable contact. The pivoting arm is rotatable about and translatable relative to the pivot member to selectively engage and disengage the fixed and moveable contacts.

### BACKGROUND OF THE INVENTION

The subject matter disclosed herein relates to the art of circuit breakers and, more particularly to a circuit breaker having a floating moveable contact.

A circuit breaker includes one or more stationary contacts and one or more moveable contacts that are connected to close a circuit to pass electrical current. In the event that the electrical current exceeds predetermined parameters, such as during a short circuit event, the moveable contact(s) is/are shifted away from the stationary contact(s) to open the circuit.

### BRIEF DESCRIPTION OF THE INVENTION

According to one aspect of an exemplary embodiment, a circuit breaker includes a housing, a fixed contact mounted in the housing, a pivot member arranged in the housing, and a pivoting arm moveably mounted in the housing. The pivoting arm includes a moveable contact. The pivoting arm is rotatable about, and translatable relative to, the pivot member to selectively engage and disengage the fixed and moveable contacts.

According to another aspect of an exemplary embodiment, a pivoting arm for a circuit breaker includes a body including a first end, a second end, and an intermediate portion, and a slot formed in the intermediate portion. The slot is defined by a wall portion. The pivoting arm is rotatable about, and translatable relative to, a pivot member.

According to yet another aspect of an exemplary embodiment, a method of shifting a pivoting arm of a circuit breaker includes pivoting the pivoting arm about a pivot member between an open position and a closed position, and translating the pivoting arm relative to the pivot member.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a circuit breaker, in accordance with an exemplary embodiment, shown in an open configuration; and

FIG. 2 is a partial cross-sectional view of a circuit breaker, in accordance with an exemplary embodiment, shown in a closed configuration.

The detailed description explains embodiments of the invention, together with advantages and features, by way of example with reference to the drawings.

### DETAILED DESCRIPTION OF THE INVENTION

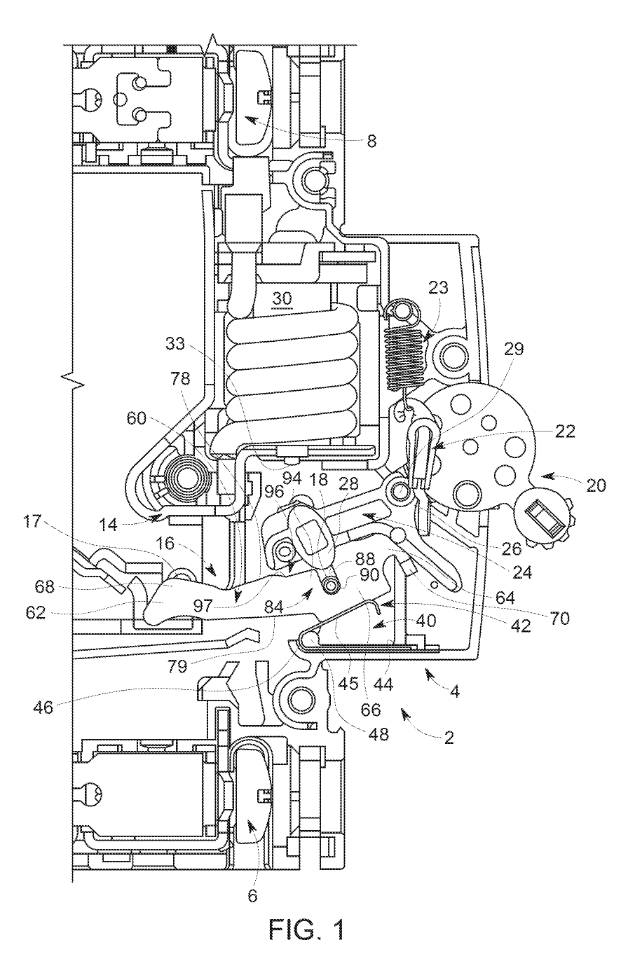

A circuit breaker, in accordance with an exemplary embodiment, is indicated generally at 2, in FIG. 1. Circuit breaker 2 includes a housing 4 that supports a first or line connector 6 and a second or load connector 8. Of course, it should be understood that the relative location of the line connector and the load connector may vary. It should also be understood that connections, e.g., line connections and load connections, may vary depending upon installation, preference, and custom. Specifically, line connector 6 may receive a load connection, and load connector 8 may receive a line connection.

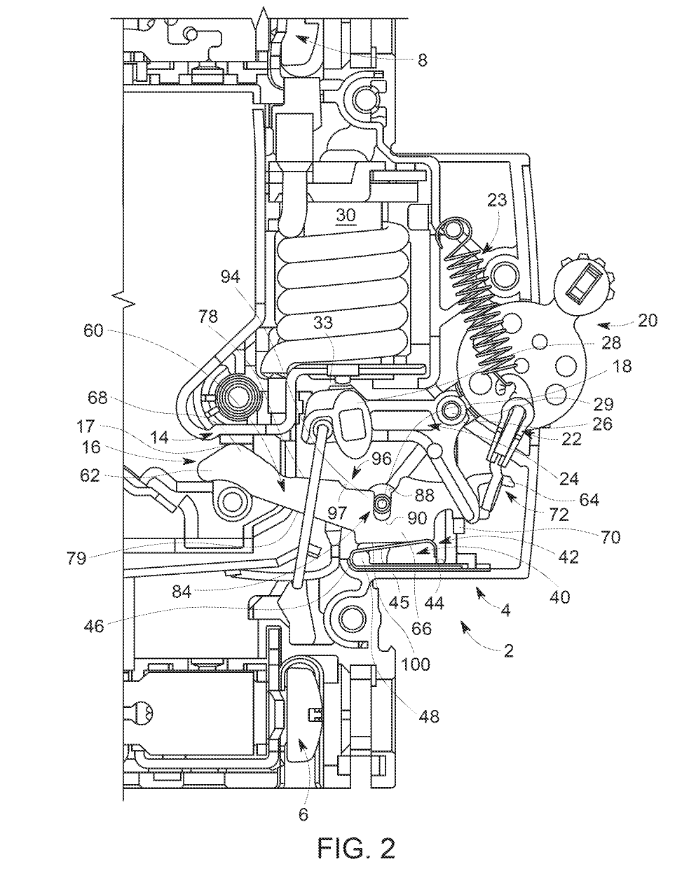

Circuit breaker 2 includes a first or stationary contact 14 which, in the exemplary embodiment shown, is electrically connected to load connector 8. Circuit breaker 2 also includes a second or pivoting arm 16 provided with a contact 17 electrically connected to line connector 6. As will be detailed more fully below, pivoting arm 16 may pivot and translate about a pivot member 18 between an open configuration (FIG. 1) and a closed configuration (FIG. 2). More specifically, pivot member 18 establishes a rotational axis (not separately labeled) for pivoting arm 16. More specifically, circuit breaker 2 includes a toggle 20 that may cause pivoting arm 16 to connect with, and disconnect from, stationary contact 14 through a clip 22 coupled to a spring 23. Circuit breaker 2 also includes a de-activation member 24. De-activation member 24 extends from a first end portion 26, to a second end portion 28 that acts upon pivoting arm 16. As will be discussed more fully below, de-activation member 24 pivots about a pin 29 to shift pivoting arm 16 away from stationary contact 14. More specifically, in the event of an over-current condition, a solenoid 30 is activated causing a plunger 33 to extend outward and contact de-activation member 24 which, in turn, engages with and causes pivoting arm 16 to move away from stationary contact 14 opening an electrical circuit.

In further accordance with an exemplary embodiment, a biasing member 40, shown in the form of a flat spring 42, urges pivoting arm 16 into contact with stationary contact 14, as will be detailed below. Biasing member 40 includes a first leg 44 that extends to a second leg 45 through a bend or curved portion 46 that wraps about a fulcrum member 48. First leg 44 abuts an inner surface (not separately labeled) of housing 4 while second leg 45 engages with pivoting arm 16. Specifically, a biasing force created in second leg 45 via fulcrum member 48 acts upon pivoting arm 16, as will be detailed more fully below. Specifically, biasing member 40 provides at least two benefits to the exemplary embodiment. Biasing member 40 advantageously urges pivoting arm 16 toward pivot member 18 and also provides a force that maintains contact between pivoting arm 16 and stationary contact 14.

In accordance with an aspect of an exemplary embodiment, pivoting arm 16 includes a body 60 having a first end 62, a second end 64 (FIG. 2) and an intermediate portion 66. Contact 17 is provided at first end 62. Contact 17 selectively engages with stationary contact 14. Second end 64 includes a trip member 70 and a manual activation/de-activation element 72. Trip member 70 extends generally, perpendicularly outwardly from body 60 and provides an interface with a trip mechanism (not shown) that reacts to an input which may be provided from a bi-metallic strip (also not shown). Trip member 70 is acted upon by the trip mechanism to move pivoting arm 16 away from stationary contact 14 in the event of, for example, an over-current condition. Manual activation/de-activation element 72 cooperates with clip 22 and toggle 20. In this manner, toggle 20 may be manipulated to manually shift pivoting arm 16 between an open configuration (FIG. 1) and a closed configuration (FIG. 2). Pivoting arm 16 also includes a first outer edge 78 and a second outer edge 79 that extend between first and second ends 62 and 64 on opposing sides of intermediate potion 66.

In further accordance with an exemplary embodiment, pivoting arm 16 includes a slot 84 formed in intermediate portion 66. Slot 84 is defined by a wall portion 88 that includes a first or curvilinear end section 90 and a second end section 94 open at first outer edge 78. Slot 84 operably receives pivot member 18 and not only allows for rotation, but also translation of pivoting arm 16. Slot 84 establishes an opening or discontinuity in outer edge 78 of pivoting arm 16.

Pivoting arm 16 also includes a de-activation surface 96 that may take the form of a recess 97 formed in first outer edge 78 at slot 84, and a biasing member contact surface 100 provided at second outer edge 79.

In accordance with an exemplary embodiment, de-activation member 24 engages with de-activation surface 96 to unseat pivoting arm 16 from stationary contact 14 against a force applied to biasing member contact surface 100 by second leg 45 of flat spring 42. Of course, it should be understood that pivoting arm 16 may also be shifted through operation of toggle 20. Toggle 20, acts upon activation/de-activation element 72 through clip 22 to rotate pivoting arm 16 away from stationary contact 14 against the force applied to biasing member contact surface 100. In this position, electrical current may not flow between line connector 6 and load connector 8. Pivoting arm 16 may also shift to a closed configuration, through rotation of toggle 20, in which first end 62 engages with stationary contact 14 allowing electrical current to flow between line connector 6 and load connector 8.

In yet still further accordance with an exemplary embodiment, when in a closed configuration as shown in FIG. 2, curvilinear end section 90 is spaced from pivot member 18. Over time, first end 62 may wear as a result of connecting and breaking a flow of electrical current. As wear occurs, pivoting arm 16 may translate further toward stationary contact 14. Specifically, curvilinear end section 90 of slot 84 may move toward pivot member 18 under an influence of the force applied by flat spring 42. Translation may occur over time and until such a time as curvilinear end section 90 rests upon pivot member 18. In this manner, circuit breaker 2 may continue to operate despite changes in surface characteristics of first end 62 and/or stationary contact 14.

At this point it should be understood that the exemplary embodiments describe a circuit breaker having a pivoting arm that both rotates about, and translates relative to, a pivot member. The pivoting arm includes a slot that facilitates the translation to accommodate wear in a contact surface(s). A benefit of the present invention lies in the incorporation of a biasing member, which may take the form of a flat spring, that urges the pivoting arm toward the pivot member and also provides a force that maintains contact between pivoting arm and a stationary contact. It should also be understood that the exemplary embodiments provide a system that allows the pivoting arm to adjust for tip wear/erosion and maintain a desired contact pressure over an overall, extended, service life of the circuit breaker. Further, the pivoting arm coupled with the biasing member, in accordance with the exemplary embodiments, ensures continued contact pressure while also achieving a reduction in parts, a simplification in an overall construction, and a reduction/elimination in potential failure points.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A circuit breaker comprising:
a housing;
a fixed contact mounted in the housing;
a pivot member arranged in the housing; and
a pivoting arm moveably mounted in the housing, the pivoting arm including a moveable contact, the pivoting arm being rotatable about and translatable relative to the pivot member to selectively engage and disengage the fixed and moveable contacts.

2. The circuit breaker according to claim 1, wherein the pivoting arm includes a first end that supports the fixed contact, an opposing second end, and a slot formed therebetween, the slot establishing a discontinuity in an outer edge of the pivoting arm.

3. The circuit breaker according to claim 2, wherein the pivoting arm includes a trip member arranged at the second end, the trip member extending substantially perpendicularly outwardly of the pivoting arm along an axis parallel to a rotational axis defined by the pivot member.

4. The circuit breaker according to claim 2, wherein the pivoting arm includes a biasing member contact surface.

5. The circuit breaker according to claim 4, wherein the biasing member contact surface is substantially adjacent to the slot.

6. The circuit breaker according to claim 4, further comprising: a flat spring including a first leg mounted to the housing and a second leg abutting the biasing member contact surface of the pivoting arm.

7. The circuit breaker according to claim 6, wherein the housing includes a fulcrum member, the flat spring extending about the fulcrum member.

8. The circuit breaker according to claim 4, wherein the pivoting arm includes a de-activation surface formed opposite the biasing member contact surface and a manual activation/de-activation element provided at the second end.

9. The circuit breaker according to claim 8, wherein the de-activation surface defines a recess formed in the outer edge of the pivoting arm, the recess extending toward the slot.

10. A pivoting arm for a circuit breaker comprising:
a body including a first end, a second end, and an intermediate portion; and
a slot formed in the intermediate portion, the slot being defined by a wall portion, the pivoting arm being rotatable about, and translatable relative to, a pivot member.

11. The pivoting arm according to claim 10, wherein the wall portion includes a first, curvilinear end section extending into the intermediate portion and a second end section open at an outer edge of the intermediate portion.

12. The pivoting arm according to claim 10, wherein the pivoting arm includes a trip member that extends substantially perpendicularly outwardly of the body at the second end.

13. The pivoting arm according to claim 10, wherein the body includes a biasing member contact surface provided on the intermediate portion.

14. The pivoting arm according to claim 13, wherein the body includes a de-activation surface formed on the intermediate portion opposite the biasing member contact surface and a manual activation/de-activation element at the second end.

15. The pivoting arm according to claim 14, wherein the de-activation surface defines a recess formed in an outer edge of the body, the recess extending to the slot.

16. A method of shifting a pivoting arm of a circuit breaker comprising:
pivoting the pivoting arm about a pivot member between an open position and a closed position; and
translating the pivoting arm relative to the pivot member.

17. The method of claim 16, wherein translating the pivoting arm includes shifting the pivoting arm outwardly of the pivot member upon moving into the closed position.

18. The method of claim 17, wherein shifting the pivoting arm outwardly includes unseating a curvilinear end section of a slot from the pivot member.

19. The method of claim 16, wherein pivoting the pivoting arm to the closed position includes applying a biasing force to the pivoting arm through a flat spring.

20. The method of claim 19, wherein pivoting the pivoting arm to the open position includes compressing the flat spring.
